(19) United States
(12) Patent Application Publication
(10) Pub. No.: US 2015/0028177 A1
(43) Pub. Date: Jan. 29, 2015

(54) TRAILER JACK STAND SUPPORT

(71) Applicant: Michael Vargas, Hayden, ID (US)

(72) Inventor: Michael Vargas, Hayden, ID (US)

(21) Appl. No.: 14/340,524

(22) Filed: Jul. 24, 2014

Related U.S. Application Data
(60) Provisional application No. 61/857,970, filed on Jul. 24, 2013.

(51) Int. Cl. B66F 13/00; B60S 9/04

(52) U.S. Cl. CPC B66F 13/00; B60S 9/04
USPC 248/542

(57) ABSTRACT

The present invention relates to a jack stand and safety support comprising: four sides that substantially form a pyramid; two of said four sides being opposite each other including cut outs and handles; a top including a three tiers basin that includes an optional drainage channel extending across all tiers and drainage holes and glow in the dark lengthwise strips along the corners of said jack stand and support.

This application claims the priority benefit under 35 U.S.C. section 119 of U.S. Provisional Patent Application No. 61/857,970 entitled “Trailer Jack Stand Support” filed on Jul. 24, 2013; which is in its entirety herein incorporated by reference.

### FIELD OF THE INVENTION

The present invention relates to a device for stabilizing a trailer jack on hard or soft ground after the trailer has been disconnected from its towing vehicle, and more particularly to a stabilizing device that can receive a wheel, a jack pad or the shaft of a jack. The present invention also relates to a safety stand of substantially fixed height of such character that it can be used to support house trailers when they are parked, the drawbar end of trailers in general or, in fact, any relatively stationary and appreciably heavy weight which needs a relatively stable support.

### BACKGROUND OF INVENTION

Various stands have been available ranging from mere blocks of wood or concrete to somewhat complicated adjustable stands which can be elevated and lowered by employment of a crank with a rack and pinion. Blocks are not always acceptable because of their weight and bulk, especially when it might be advantageous to move them together with the vehicle. Adjustable-type stands often are not stable enough to be dependable and, when constructed in a stable fashion, are frequently unnecessarily expensive. They also have the disadvantage of not being readily stowed.

In setting up a mobile home trailer, a manufactured building or other similar structures and objects, the structure must be blocked and supported. One simple method employed for blocking the structure is to use a plurality of concrete blocks stacked up on top of each other. As each concrete block has a limited footprint, each block stack has a limited weight capacity with respect to the ground. Therefore, in order to support modern structures, wherein several thousand pounds must typically be supported, two or more side by side block stacks must be established. Not only is a series of concrete block stacks aesthetically unpleasant, the need to bring a large number of concrete blocks to the job sight is expensive and labor intensive. Additionally, a relatively high concrete block stack may tend to be unstable under various loads and environmental conditions.

In order to overcome the problems of using only concrete blocks to support a structure various devices have been proposed. Such devices, although working with varying degrees of efficiency, tend to be difficult to use and maintain and are unduly heavy ad bulky.

Therefore, there is a need in the art for a structure support stand that addresses the above-stated problems in the art. Such a device must be capable of supporting several thousand pounds and must not be an eye sore. Such a device must be relatively lightweight and easy to transport, assemble and use. Ideally, such a device will be relatively inexpensive to manufacture and maintain.

### OBJECTS OF THE INVENTION

A primary object of the present invention is to provide a new and improved jack stand for supporting stationary vehicles and other weights which is very rugged in its construction, and simple in its assembly and or construction.

Another object of the invention is to provide a new and improved stand for supporting vehicles and comparable loads, parts of which are uniform and interchangeable, and, which though particularly rugged, has a structural arrangement permitting it to be relatively light in weight compared to the amount of load it is capable of carrying.

Still another object of the invention is to provide a new and improved stand for supporting stationary loads which besides being stable in a position for one selected height, can be shifted to accommodate a different selected height without sacrificing its rugged stability.

Still another object of the supporting is to provide a new and improved stand for supporting stationary loads which is relatively simple and inexpensive not only to manufacture and is build in such a way that it occupies a relatively compact space.

With these and other objects in view, the invention consists in the construction, arrangement, and combination of the various parts of the device, whereby the objects contemplated are attained, as hereinafter set forth, pointed out in the appended claims and illustrated in the accompanying drawings.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE FIGURES

FIG. 1 is a top view of the stand support of the invention.

FIG. 2 is a top planar view of the stand support of the invention.

FIG. 3 is a side view of the device of the invention.

FIG. 4 is another side view of the stand support of the invention.

FIG. 5 is a bottom view of the stand support of the invention.

FIG. 6 shows a dissected view of the device of the invention.

FIG. 7 illustrates an inside view of the device of the invention.

FIG. 8 is a perspective view of the stand support of the invention.

FIG. 9 is a side elevational view of the stand in use in supporting a trailer.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

### SUMMARY OF THE INVENTION

The instant invention provides a jack stand and safety support comprising: four sides that substantially form a pyramid; two of said four sides being opposite each other and including cut outs and handles; a top including a three tier basin that includes an optional drainage channel extending across all tiers and glow in the dark lengthwise strips along the corners of said jack stand and support.

The present invention also provides a safety support base for a trailer to eliminate the chance of it accidentally falling off the homemade block it sits on, preventing costly damage and possible injury or death. It also provides additional safety features with its bright hunters orange body and built in military style luminescent base and edges, providing an illuminated perimeter around you and your property to warn other drivers of your location at night.

The support base or stand comes in different sizes to accommodate specific style trailers. The stand is the standard size block which could be used for traditional RVs, Boat, ATV, or pull behind utility trailer. Larger sizes or heavy duty blocks are designed to be used with 5th wheels and works the same way. The small size is a low profile block which could be combined with other sizes and is used as a scissor jack support and illuminated perimeter. The supports or stands of the invention are equipped with military grade glow in the dark strips allowing your trailer to be seen from a distance and allowing you to recognize the location of the hitch during dark hours to prevent you from bumping into it and injuring yourself

The support or stand of the invention is a pyramid shaped plastic block that is light weight, and comes in a bright hunters orange colors with military grade glow in the dark strips on its edges and base for high visibility. It has built-in inverted handles for easy carrying and positioning. It also has an indented square pocket located on the top to allow the jack stand foot to fit into the “pocket”. The design allows the trailer jack stand to securely sit into the stand or support, preventing it from sliding off the block. The wide base and pyramid design also prevents the block from tipping over in the event of an earthquake, high winds or shifting of the trailer or the ground beneath it.

The smaller sizes are also pyramid shaped, light weight plastic block in a bright hunter's orange with military grade glow in the dark strips on its edges and base for high visibility. It also has a deep pocket which allows the scissor jack foot to securely fit into it preventing it from digging into the surface underneath it and helping to provide a safer and more sturdy foundation.

### DETAILED DESCRIPTION OF THE INVENTION

The stationary jack stand/support shown in the accompanying drawings and described below are examples which embody the invention. It should be noted that the scope of the invention is defined by the accompanying claims, and not necessarily by specific features of exemplary embodiments.

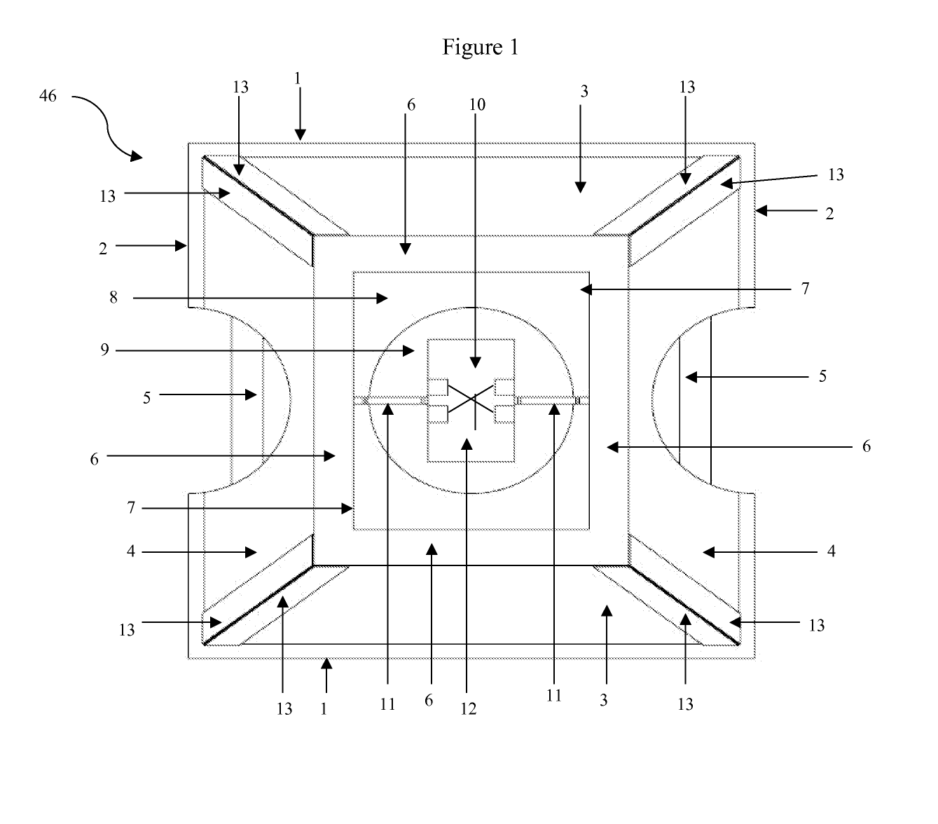

For the convenience of the reader, and with respect to FIGS. 1, 3, 5, 6, 7 and 8 the following correlation between reference numbers and elements of the invention is provided:
1 represents the pyramid base support
2 is the pyramid base with carved outs for handles
3 pyramid base side wall
4 pyramid base side wall with cut out and molded handles
5 are the molded handles
6 pyramid base top
7 is a 3 tier jack stand support basin
8 first tier is a rectangular jack stand foot support
9 second tier is a circular jack stand foot support
10 third tier is a wheeled jack stand foot support
11 is an optional drainage channel extending through all the tiers
12 drain holes located on the third tier
13 glow in the dark corner strips
14 molded base support ribs
15 empty cavities next to support ribs

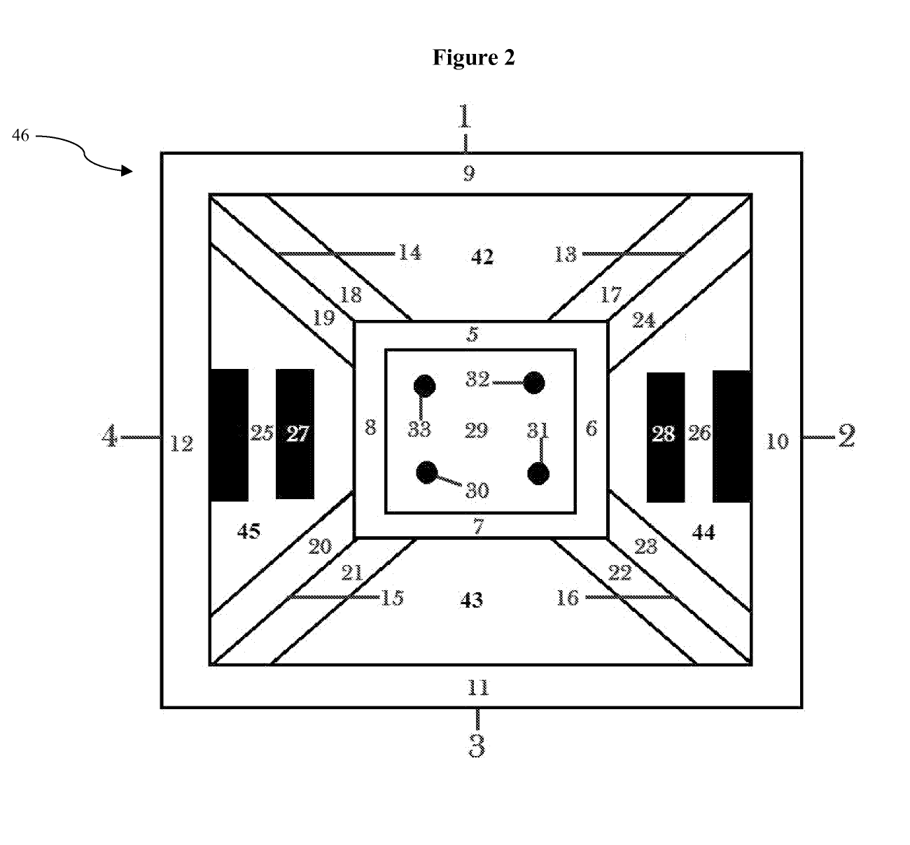

With respect to FIGS. 2, 4, and 9 the following correlation between reference numbers and elements of the invention is provided:
1, 2, 3, 4 represents the base grip of the support which can be made of rubber or other polymeric or metallic materials that are suitable for such base grip and may also contain grooves.
5, 6, 7, 8, represent the top of the pyramidal support of the invention.
9, 10, 11, 12 are glow in the dark base lip
13, 14, 15, 16 are the pyramid base edges
17, 18, 19, 20, 21, 22, 23, 24 are glow in the dark edging strips
25, 26 are molded system handles
27, 28 are molded indented hand grooves for handles
29 indented jack stand support stabilizing basin
30, 31, 32, 33 represent jack stand support stabilizing basin drain holes,
34 molded base support system
35 molded base support system drain grooves
37 draw bar
38 trailer
42, 43, pyramid base wall without handles
44, 45 pyramid base wall with molded handles and hand grooves

FIG. 1 illustrates a top view of the jack stand or support of the invention 46 comprising base 1 and base 2 having cut outs for handles, four side walls designated a numerals 3 and 4, where side wall 4 includes the cut outs and handles 5, and a top 6. The four side walls 3 and 4 extend upward from the base 1 and 2 to substantially form a pyramid. The top 6 of the support of the invention includes a three tier jack stand support basin 7, that includes a rectangular jack stand foot support 8, a circular jack stand foot support 9 and a wheeled jack stand foot support 10. The support basin 7 includes an optional drainage channel 11 extending through all the tiers, drain holes 12 located on wheeled jack stand support 10. The jack stand or support of the invention also includes glow in dark corner strips 13. The glow in the dark corner strips 13 can be luminescent strips, chemiluminescent strips or electrochemiluminescent strips. The corner glow in the dark strips run lengthwise from the bottom of the pyramid to the top of the pyramid.

FIG. 2 is another view of the jack stand and support of the invention illustrating a base grip of the support shown by numerals 1, 2, 3, 4 which can be made of rubber or other polymeric or metallic materials or plastic composites that are suitable for such base grip and may optionally contain grooves. The device of the invention further has a top shown by numerals 5, 6, 7, 8 and a glow in the dark base lip designated by 9, 10, 11, 12. Reference numerals 13, 14, 15, 16 designate the pyramid base edges and the glow in the dark edging strips are shown by numerals 17, 18, 19, 20, 21, 22, 23, 24. The device further includes molded handles 25 and 26 and also includes molded indented hand grooves 27, 28 for handles. The top of the jack stand and support has a stabilizing basin 29 and the basin also includes drain holes 30, 31, 32, 33. Reference numerals 42 and 43 illustrate the pyramid base wall without handles, while reference numerals 44 and 45 denotes a pyramid base wall with molded handles and hand grooves.

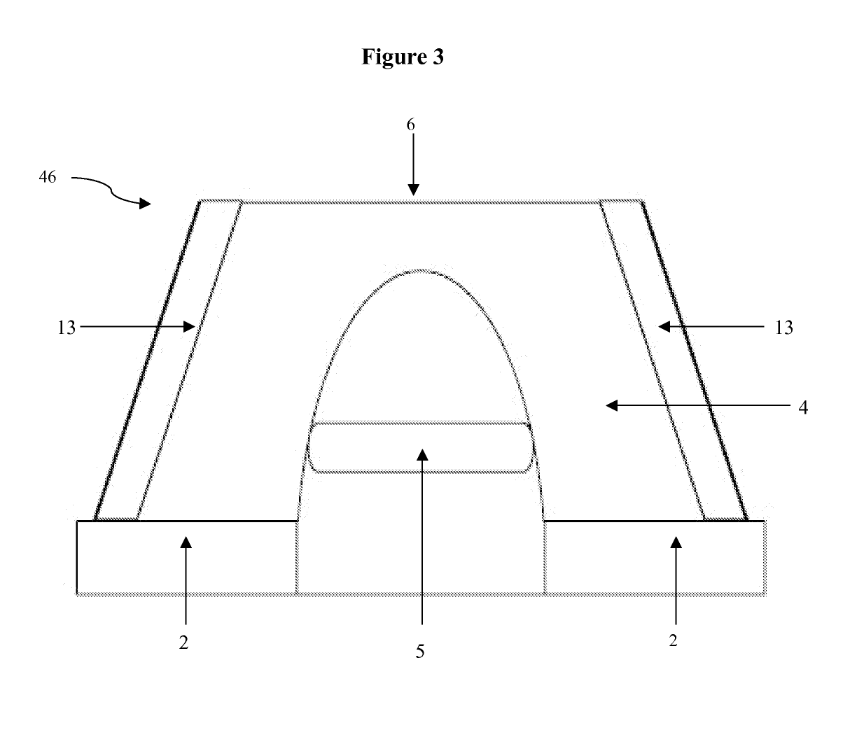

FIG. 3 is a side view of the jack stand or support 46 of the invention illustrating the base 2, handle 5, side wall 4, top 6 and glow in the dark corner strips 13.

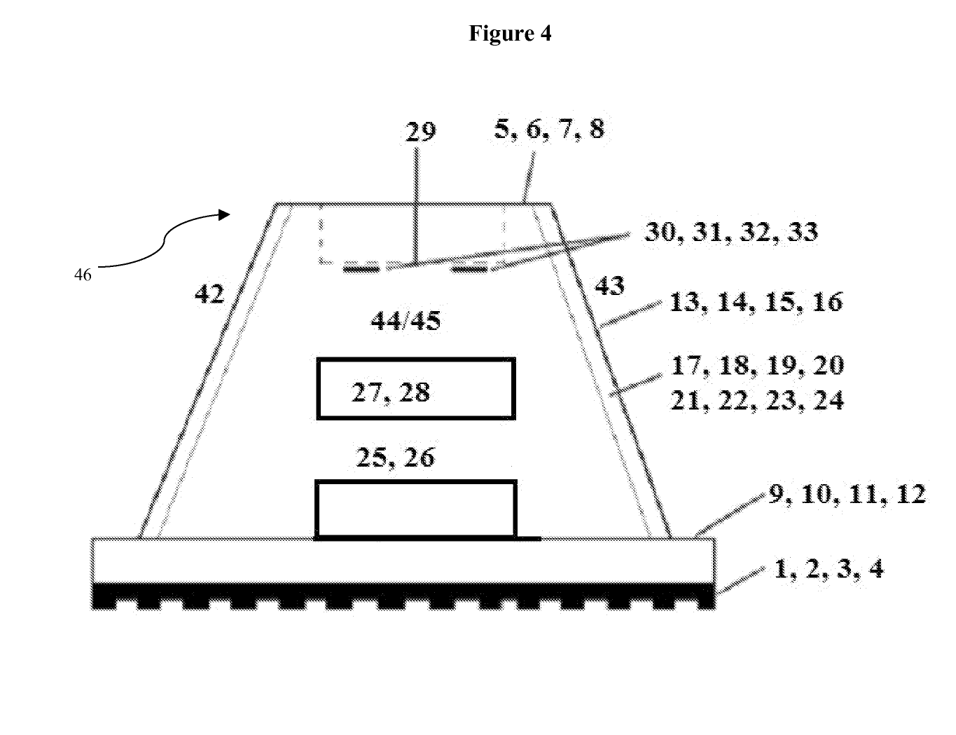

FIG. 4 is a side view of the embodiment of FIG. 2 wherein 46 is the device of the invention. The device includes a base grip for the support shown by reference numerals 1, 2, 3, 4 which can be made of rubber or other polymeric or metallic materials or plastic composites that are suitable for such base grip and may optionally contain grooves. The device of the invention further has a top shown by numerals 5, 6, 7, 8 and a glow in the dark base lip designated by 9, 10, 11, 12. Reference numerals 13, 14, 15, 16 designate the pyramid base edges and the glow in the dark edging strips are shown by numerals 17, 18, 19, 20, 21, 22, 23, 24. The device further includes molded handles 25 and 26 and also includes molded indented hand grooves 27, 28 for handles. The top of the jack stand and support has a stabilizing basin 29 and the basin also includes drain holes 30, 31, 32, 33. Reference numerals 42 and 43 illustrate the pyramid base wall without handles, while reference numerals 44 and 45 denotes a pyramid base wall with molded handles and hand grooves.

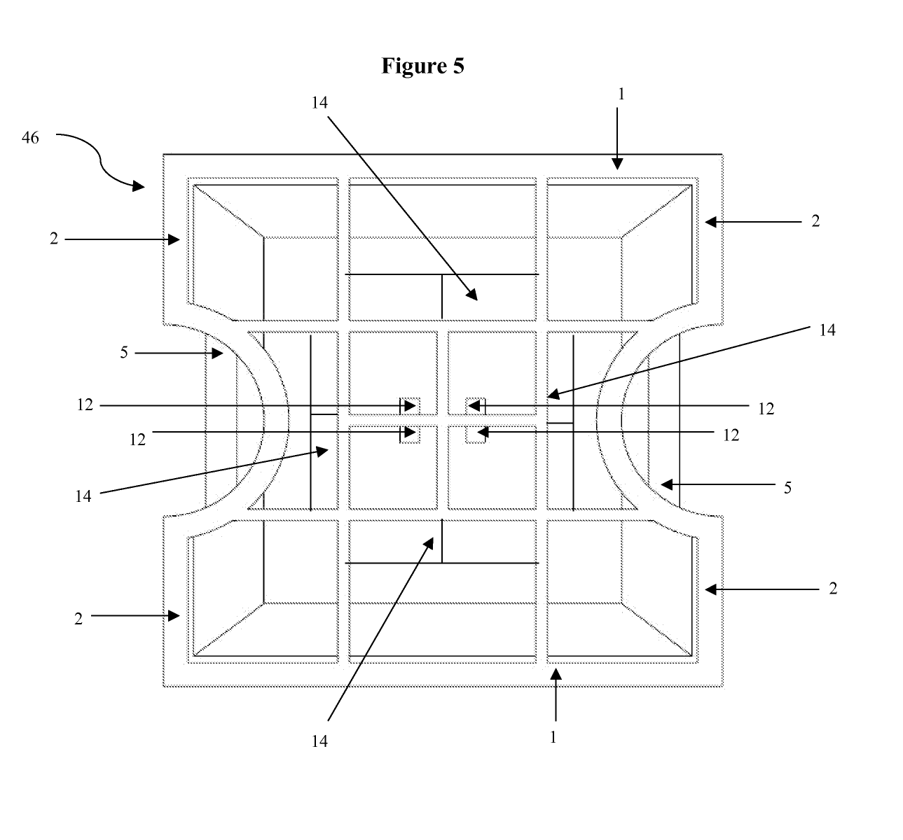

FIG. 5 is a bottom view of the jack stand or support 46 of the invention illustrating base 1 and base 2, handles 5, drainage holes 12 on tier 10 and support ribs 14 on molded base 1 and base 2.

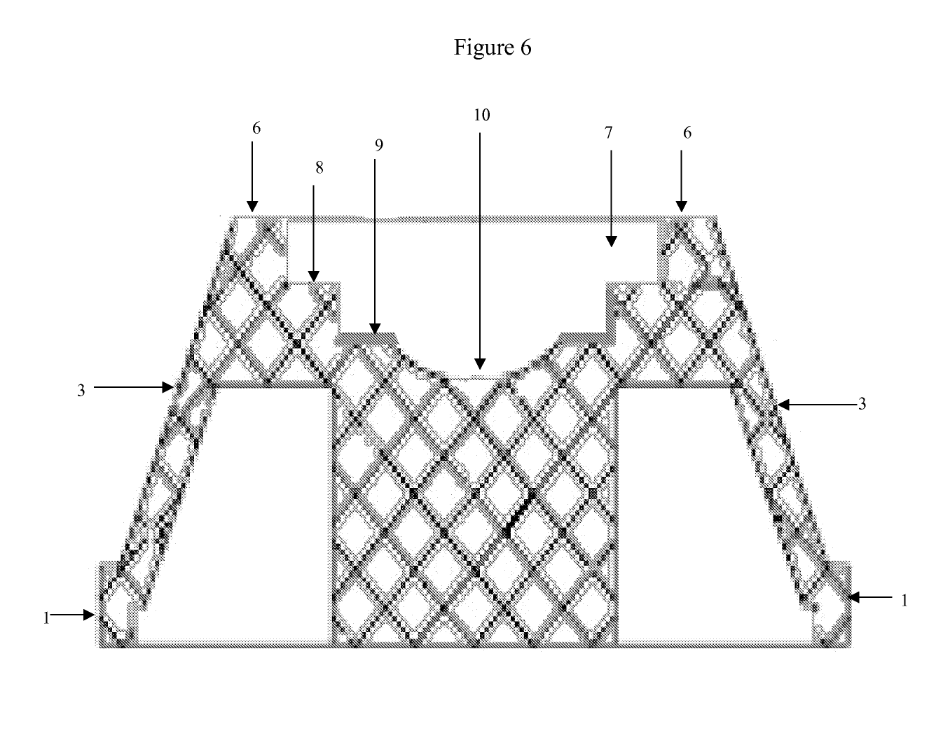

FIG. 6 is a dissected view of the jack stand and safety support of the invention illustrating base 1, side walls 3, and top 6. The top 6 of the support of the invention includes a three tier jack stand support basin 7, that includes a rectangular jack stand foot support 8, a circular jack stand foot support 9 and a wheeled jack stand foot support 10.

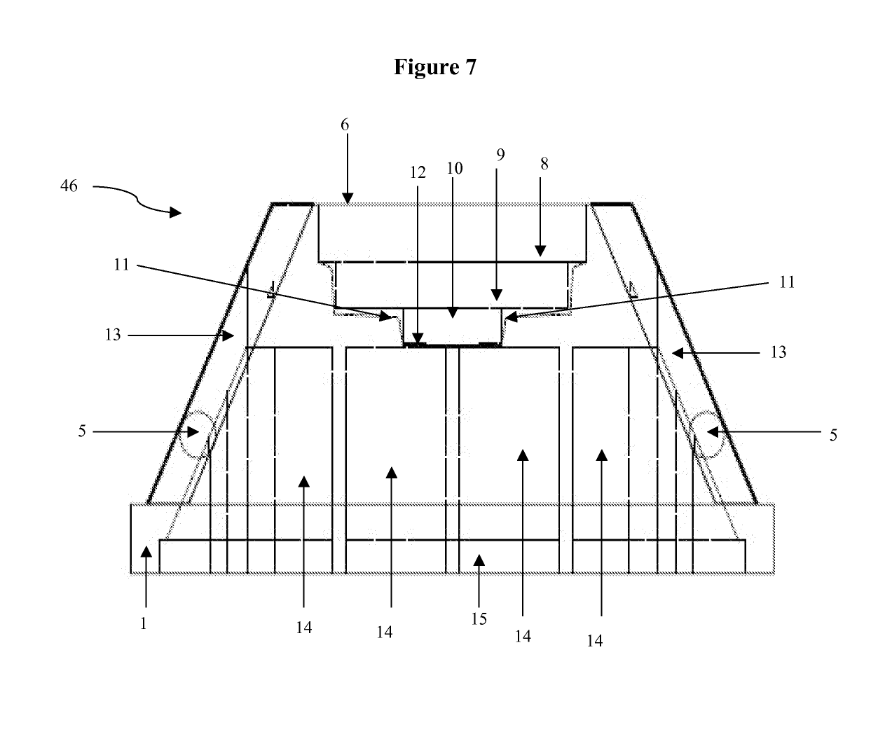

FIG. 7 is a side view of the device 46 of the invention illustrating the inside aspects of the device. The device 46 of FIG. 7 includes a base 1 and a top 6. The top 6 of the support of the invention includes a three tier jack stand support basin 7, that includes a rectangular jack stand foot support 8, a circular jack stand foot support 9 and a wheeled jack stand foot support 10. The support basin 7 optionally includes an optional drainage channel 11 extending through all the tiers, drain holes 12 located on wheeled jack stand support 10. The jack stand or support of the invention also includes glow in dark corner strips 13. The glow in the dark corner strips 13 can be luminescent strips, chemiluminescent strips or electrochemiluminescent strips. The corner glow in the dark strips run lengthwise from the bottom of the pyramid to the top of the pyramid. The device 46 of FIG. 7 as shown on the inside includes molded support ribs 14 and empty cavities 15 next to the support ribs.

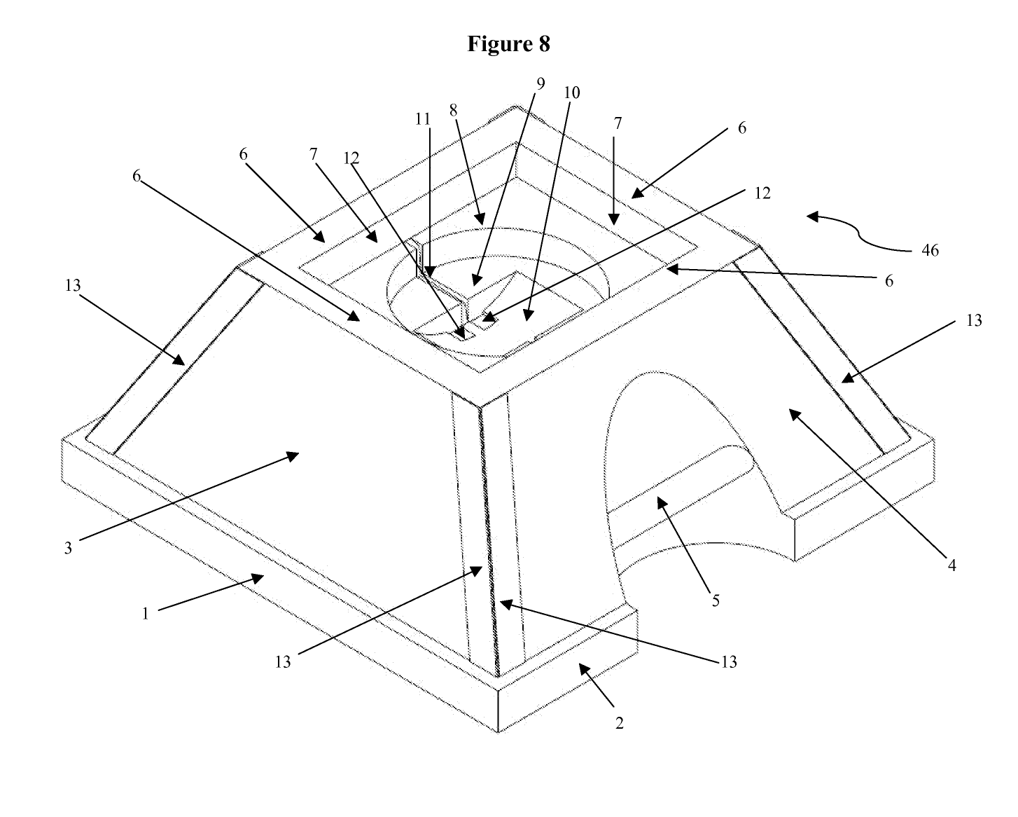

FIG. 8 is a perspective view of the jack stand or support 46 of the invention showing base 1 and base 2, side walls 3 and 4, handle 5, and top 6. The top 6 of the support of the invention includes a three tier jack stand support basin 7, that includes a rectangular jack stand foot support 8, a circular jack stand foot support 9 and a wheeled jack stand foot support 10. The support basin 7 includes an optional drainage channel 11 extending through all the tiers, drain holes 12 located on wheeled jack stand support 10. The jack stand or support of the invention also includes glow in dark corner strips 13.

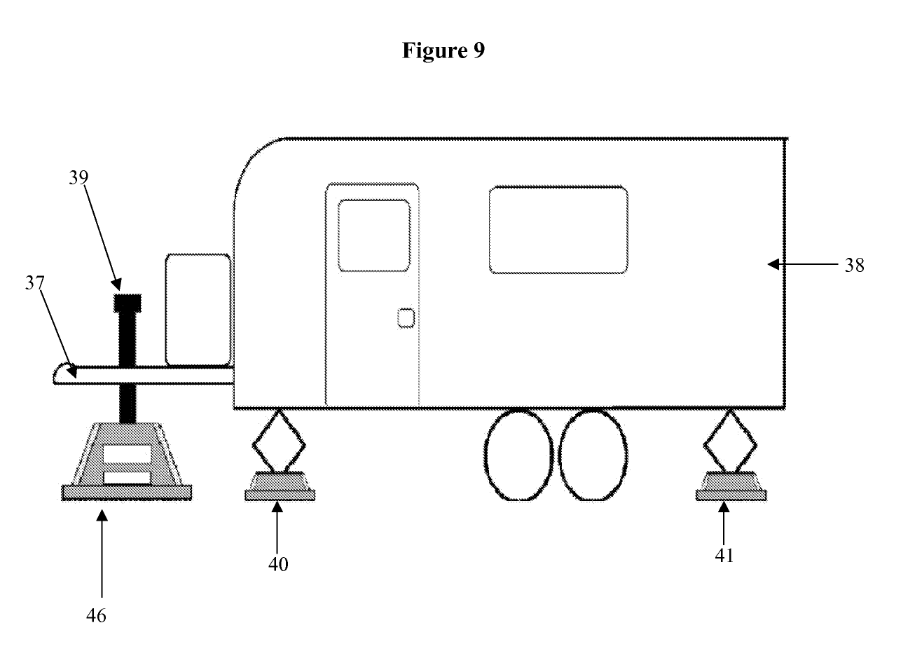

In an embodiment of the invention chosen for the purpose of illustration, there is shown a stationary jack support/stand device 46 typified in use supporting a draw bar 37 of a trailer 38 as shown in FIG. 9.

The device of the invention can be manufactured using conventional molding techniques known in the art of engineering thermoplastics.

The contents of all references cited in the instant specifications and all cited references in each of those references are incorporated in their entirety by reference herein as if those references were denoted in the text.

The inventors hereby state their intent to rely on the Doctrine of Equivalents to determine and assess the reasonably fair scope of the present invention as pertains to any apparatus not materially departing from but outside the literal scope of the invention as set forth in the following claims.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting.

It is to be understood that the terms used herein are merely descriptive rather than limiting and that various changes, numerous equivalents may be made without departing from the spirit or scope of the claimed invention.

What is claimed is:

1. A jack stand and support comprising: a base, four sides that substantially form a pyramid; two of said four sides being opposite each other includes cut outs and handles; a top including a three tiers basin that includes drainage holes; and glow in the dark lengthwise strips along the corners of said jack stand and support.

2. The jack stand and support of claim 1, wherein one of said tiers is a rectangular jack stand foot support.

3. The jack stand and support of claim 1, wherein one of said tiers is a circular jack stand foot support.

4. The jack stand and support of claim 1, wherein one of said tiers is a wheeled jack stand foot support.

5. The jack stand and support of claim 1, wherein said glow in the dark strips are luminescent strips.

6. The jack stand and support of claim 1, wherein said glow in the dark strips are chemiluminescent strips.

7. The jack stand and support of claim 1, wherein said glow in the dark strips are electroluminescent strips.

8. The jack stand and support of claim 1, wherein said three tier basin optionally includes drainage channels.
